(19) United States
(12) Patent Application Publication
(10) Pub. No.: US 2003/0102196 A1
(43) Pub. Date: Jun. 5, 2003

(54) Bidirectional linear motor

(75) Inventors: Kyle Wetzel, Lawrence, KS (US); Tom Sherwood, Topeka, KS (US); Wade Nachtigall, Lawrence, KS (US); Doug Dubois, Lawrence, KS (US); Alex Chong, Lawrence, KS (US)

Correspondence Address: HOVEY WILLIAMS TIMMONS & COLLINS, 2405 GRAND BLVD., SUITE 400, KANSAS CITY, MO, 64108

(73) Assignee: Aerotech Engineering & Research Corporation

(21) Appl. No.: 10/007,258

(22) Filed: Dec. 5, 2001

(51) Int. Cl. F16D 27/12

(52) U.S. Cl. 192/48.2; 192/38; 192/84.8

(57) ABSTRACT

A small displacement, preferably bidirectional motor (20) is provided which includes a chassis (22), main actuator assembly (24), and forward and rearward clutch assemblies (26,28), as well as an output (106-110) coupled to an external load (222) to be translated. The main actuator assembly (24) includes a plurality of primary magnetostrictive actuators (50-54). The clutch assemblies (26,28) each have a secondary magnetostrictive actuator (88,148), a ramp (90, 150) interengageable with a roller cage (136, 196), and are designed as passively-engaged, actively-disengaged, one-way clutches which are unloaded before disengagement thereof in order to prevent undue clutch wear. Forward translation of the output (106-110) is obtained by inchworm-type incremental motion, whereas rearward translation occurs by an initial forward motion followed by a greater rearward motion to achieve a net rearward displacement.

### BACKGROUND OF THE INVENTION

1. Field of the Invention

The present invention is broadly concerned with improved, high-speed, preferably bidirectional motors of the type employing current-responsive small displacement actuators such as magnetostrictive stacks or piezoelectric assemblies in order to translate external loads. More particularly, the invention is concerned with such motors which include passively-engaged, actively-disengaged clutch assemblies which assume the engaged, locking position thereof under the influence of an external load, and which can be repeatedly disengaged without clutch damage. The motors of the invention employ an inchworm-type forward motion cycle, and a “one-step, three-steps rearward” cycle in order to obtain rearward motion.

2. Description of the Prior Art

Linear or rotary motion motors employing small displacement actuators are known and have been adapted for many uses requiring high-speed, controlled translatory movements of relatively small magnitudes. Generally speaking, these motors operate by repeatedly and at relatively high frequency activating and deactivating small displacement elements, which are generally in the form of either magnetostrictive or piezoelectric assemblies with associated electrical and mechanical components. Each end of the small displacement elements is connected directly or indirectly to separate locking mechanisms. When the element is activated it elongates, moving one of the locking mechanisms a predetermined distance, whereupon the locking mechanism is reengaged. Thereafter, the other locking mechanism is disengaged and moved in the same direction. This process is repeated at a high rate, allowing the motor output to inch forwardly. Generally speaking, the locking devices (e.g., clutches) employ either actively controlled clamping of the external load during expansion and contraction of the small displacement elements, or they employ devices which passively hold the load, such as one-way-running bearings or similar devices.

U.S. Pat. Nos. 5,041,753 and 6,040,643 describe the use of actively clamped locking mechanisms. The '753 patent discloses electrically operated solenoid locks, which prevent undesired rotary motion of the system when activated. On the other hand, the '643 patent makes use of electromagnetic clamping assemblies. In this system, undesired movement of the armature is prevented by activating one or both of the electromagnets in the clamping systems. Both of these patents therefore describe motors which require the use of “secondary” clamps, which have holding forces equal to that of the primary actuator element. This significantly increases the power requirement and complexity of these systems.

U.S. Pat. No. 5,079,460 provides rotational actuation using magnetostrictive assemblies and roller locking mechanisms. The latter employ compression springs in order to bias conical rollers which fix the system. Such roller locking mechanisms are deemed insufficient and unreliable in that undesired movement of the system can occur.

U.S. Pat. No. 5,530,312 describes a motor providing only unidirectional translatory linear motion through use of magnetostrictive and piezoelectric actuators. The roller locking mechanisms of this system are passively locked to prevent undesired motion during each unidirectional cycle of motion. U.S. Pat. No. 5,705,863 describes a bidirectional linear motor which uses passive locking devices. A spring is employed to bias rollers against ramps in the locking device, allowing motion in only one direction. In order to switch directions, a pair of solenoid-disengaged rail locks are employed. However, while switching directions, the '863 device disengages the locking devices while they are under load. Such a system causes excessive damage to the rollers, owing to the fact that the locking devices must repeatedly be forcibly disengaged during operation. Further, the use of solenoids is disadvantageous inasmuch as solenoids have limited output force and are generally unable to operate at high rates of speed for extended periods.

### SUMMARY OF THE INVENTION

The present invention overcomes the problems outlined above and provides a greatly improved linear or rotary motor which in preferred forms is capable of generating controlled, high-frequency bidirectional motion so as to translate an external load. Broadly speaking, preferred motors in accordance with the invention include an output adapted for coupling with the external load for selective movement thereof, together with a drive operatively connected with the output for controlled movement of the output, the drive comprising a current-responsive, selectively activatable actuator assembly operable for translation of the output, together with a pair of spaced-apart translation-controlling clutch assemblies coupled with the actuator assemblies. The clutch assemblies are capable of alternately assuming engaged and disengaged positions during movement cycles of the motor. At least one of the clutch assemblies, and preferably both, are constructed so that they assume the engaged position thereof under the influence of the external load, and are unloaded and then disengaged upon appropriate activation of the actuator assembly. Thus, the clutch assemblies are passively-locked, actively-disengaged one-way clutches which are unloaded before disengagement thereof.

The actuator assembly comprises at least one device which will alternately expand and contract under the influence of applied current, such as a magnetostrictive stack or a piezoelectric assembly. In preferred forms, the actuator assembly is made up of a plurality of magnetostrictive stack devices.

A particularly preferred drive motor in accordance with the invention includes a tubular metallic chassis presenting an output end, with a bidirectionally movable output adjacent the latter. A drive is connected with the output for selective bidirectional movement thereof, and includes a current-responsive, selectively activatable actuator assembly for alternate translation of the output in opposite first and second directions, with a pair of spaced-apart, translation-controlling clutch assemblies coupled with the actuator assembly. The actuator assembly is made up of a primary actuator having a current-responsive primary device which is alternately expandable and contractible. The clutch assemblies are located on opposite sides of the primary actuator with each clutch assembly having first and second selectively interengageable components and capable of alternately assuming engaged and disengaged positions. The primary actuator is operably coupled with the first clutch components of both of the clutch assemblies for movement of these first components away from each other upon expansion of the device, and movement of the first components towards each other upon contraction of the device. The clutch assemblies are designed so that they each assume the disengaged position thereof upon movement of the first components in the same direction.

The preferred actuator assembly also includes opposed secondary actuators each having a current-responsive secondary device which is alternately expandable and contractible; each of the secondary actuators is coupled with the second component of one of the clutch assemblies, and are operable to move the corresponding second clutch components away from each other upon expansion of the secondary actuators, and towards each other upon contraction of the secondary actuators.

Again, the preferred primary and secondary devices are respective magnetostrictive stacks which are controlled so as to provide the desirable bidirectional movement of the output. The first clutch components comprise a ramp presenting obliquely oriented engagement surfaces, whereas the second clutch components comprise cage-supporting plural rollers. The cage rollers and ramp engagement surfaces are oriented so that upon appropriate relative movement of the cages and ramps will cause the rollers to be clamped between the ramp surfaces and adjacent surfaces of the surrounding chassis, thus engaging the clutches. As noted previously, the preferred clutch design is such that the external load will cause and maintain engagement thereof unless actively unloaded and then disengaged through activation of the actuator assembly.

The preferred drive motors of the invention utilize an inchworm-style of forward motion wherein the forward clutch assembly is disengaged and then moved forwardly under the influence of the primary actuator until the primary actuator reaches its maximum extended position. At this point, as the actuator begins to contract, the forward clutch is locked and the rearward clutch is disengaged and then moved forwardly until the minimum contracted position is reached. This forward motion cycle is then repeated as necessary to obtain the desired extent of forward translatory motion.

Rearward motion on the other hand makes use of the primary actuators as well as the secondary actuators. In such reverse translatory motion, the motor output is first moved in a forward direction for an initial distance, and is then moved in a rearward direction for a distance greater than the initial distance, resulting in net movement of the output in the rearward direction. It will be appreciated that this “one-step forward, three-steps rearward” method occurs in a single predetermined reverse motion motor cycle in order to obtain rearward motion.

The motors of the invention are designed to operate at very high speeds depending upon the amplitude and frequency of the applied activating current. When using a parabolic current wave form and a frequency on the order of 500 Hertz, the resultant output movement, though in fact incremental, is effectively continuous.

### BRIEF DESCRIPTION OF THE DRAWING FIGURES

FIG. 1 is a perspective view of a preferred linear motor in accordance with the invention;

FIG. 2 is a fragmentary vertical sectional view of the linear motor of FIG. 1, depicting internal components thereof;

FIG. 3 is a fragmentary, enlarged, vertical sectional view illustrating in detail the rear clutch assembly of the linear motor;

FIG. 4 is a fragmentary, enlarged, vertical sectional view depicting the adjacent inner ends of the cage actuators of the linear motor;

FIG. 5 is a fragmentary, enlarged, vertical sectional view depicting in detail the forward clutch assembly of the linear motor;

FIG. 6 is an enlarged fragmentary view similar to that of FIG. 3 and illustrating the construction of the rear clutch assembly;

FIG. 7 is a fragmentary sectional view schematically illustrating the connection between the forward and rearward ends of the clutch cage actuators;

FIG. 8 is a fragmentary, enlarged, partial sectional view illustrating the construction of the forward clutch assembly;

FIG. 9 is an end elevational view of the rearward end of the linear motor;

FIG. 10 is a vertical sectional view taken along line 10-10 of FIG. 2 and illustrating the rear clutch actuator and rear cage sleeve;

FIG. 11 is a vertical sectional view taken along line 11-11 of FIG. 2 and depicting in detail the construction of the cage and roller unit and the shiftable ramp;

FIG. 12 is a vertical sectional view taken along line 12-12 of FIG. 2, illustrating the construction of the forward clutch actuator and the three primary actuators;

FIG. 13 is a vertical sectional view taken along line 13-13 of FIG. 2 and illustrating the construction of the forward clutch actuator and forward clutch cage;

FIG. 14 is a fragmentary vertical sectional view taken along line 14-14 of FIG. 13 and illustrating the cage actuation displacement sensor assembly;

FIG. 15 is a graph of actuator elongation versus time during forward movement of the motor output;

FIG. 16 is a graph of forward and rearward ramp positions versus time during a cycle of forward movement of the motor output;

FIG. 17 is a graph of actuator elongation versus time during a cycle of rearward movement of the motor output; and

FIG. 18 is a graph of forward and rearward ramp positions versus time during a cycle of rearward movement of the motor output.

### DETAILED DESCRIPTION OF THE PREFERRED EMBODIMENTS

Turning now to the drawings, a linear motor 20 in accordance with the invention broadly includes a rigid metallic chassis 22, a main actuator assembly 24, forward clutch assembly 26, rearward clutch assembly 28, and sensor assembly 29. The motor 20 is designed to produce incremental bidirectional controlled linear motion at high frequencies in order to translate external load.

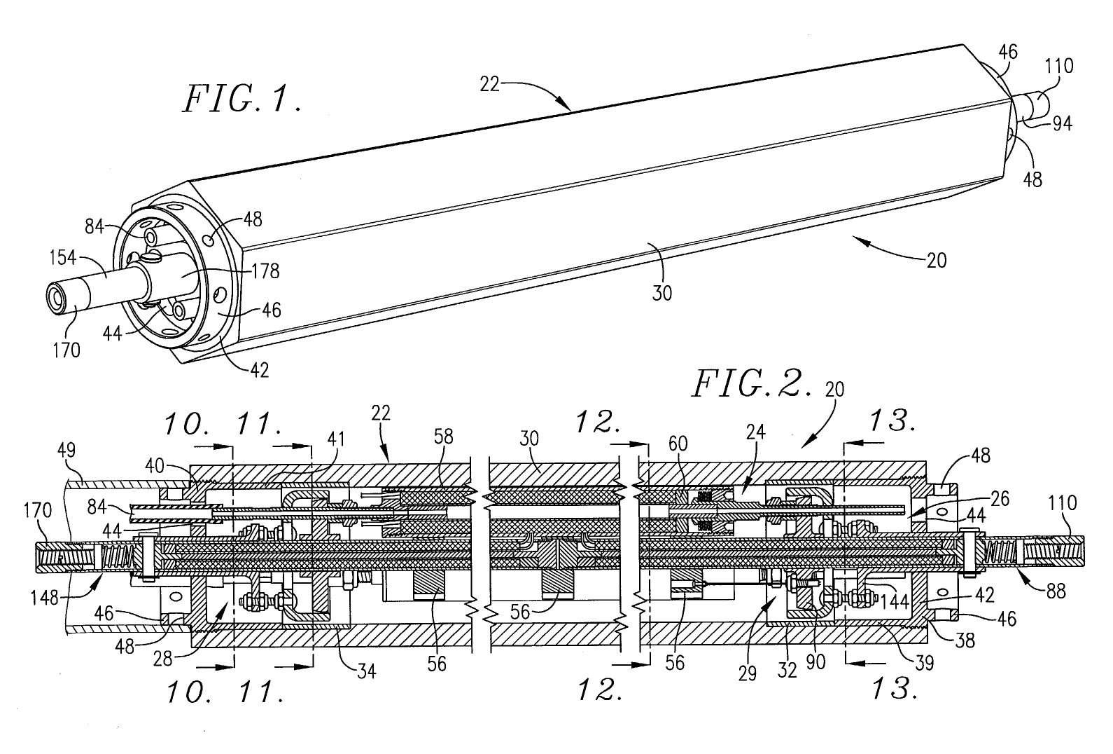

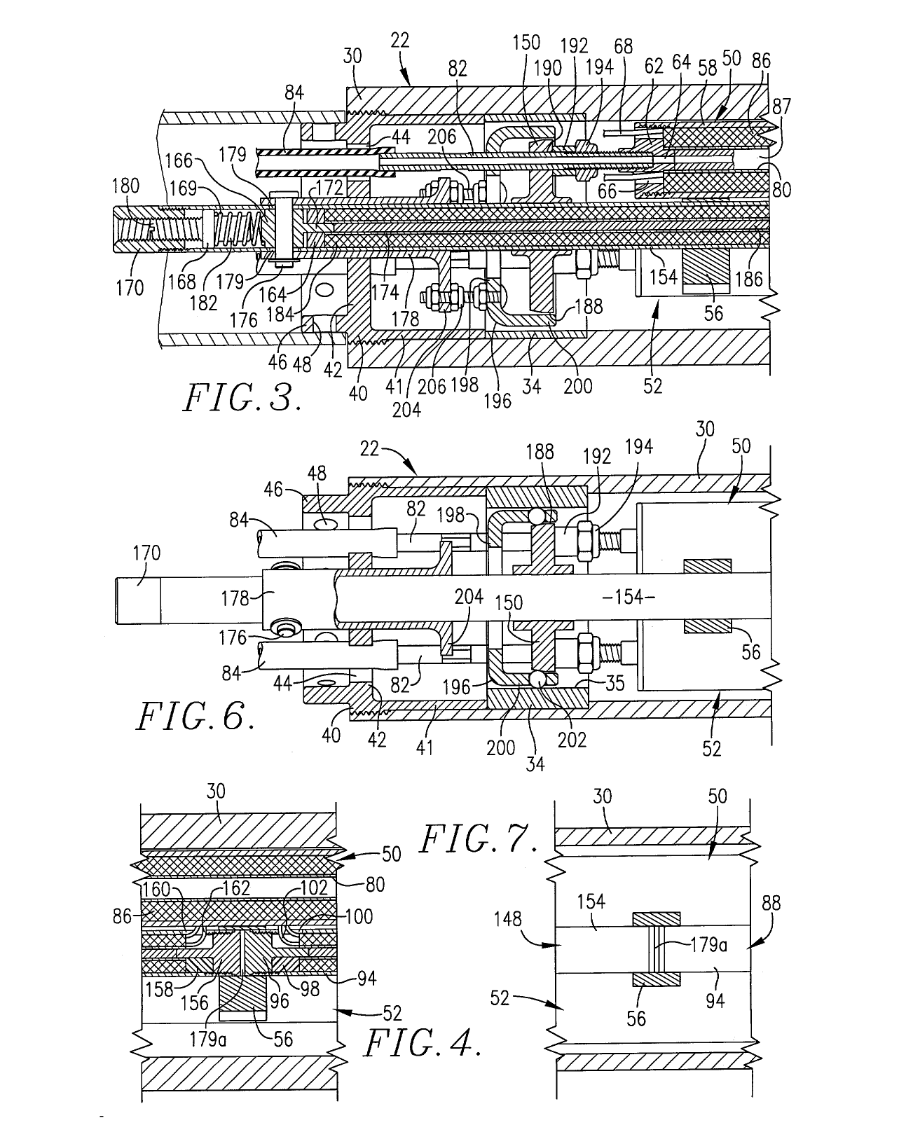

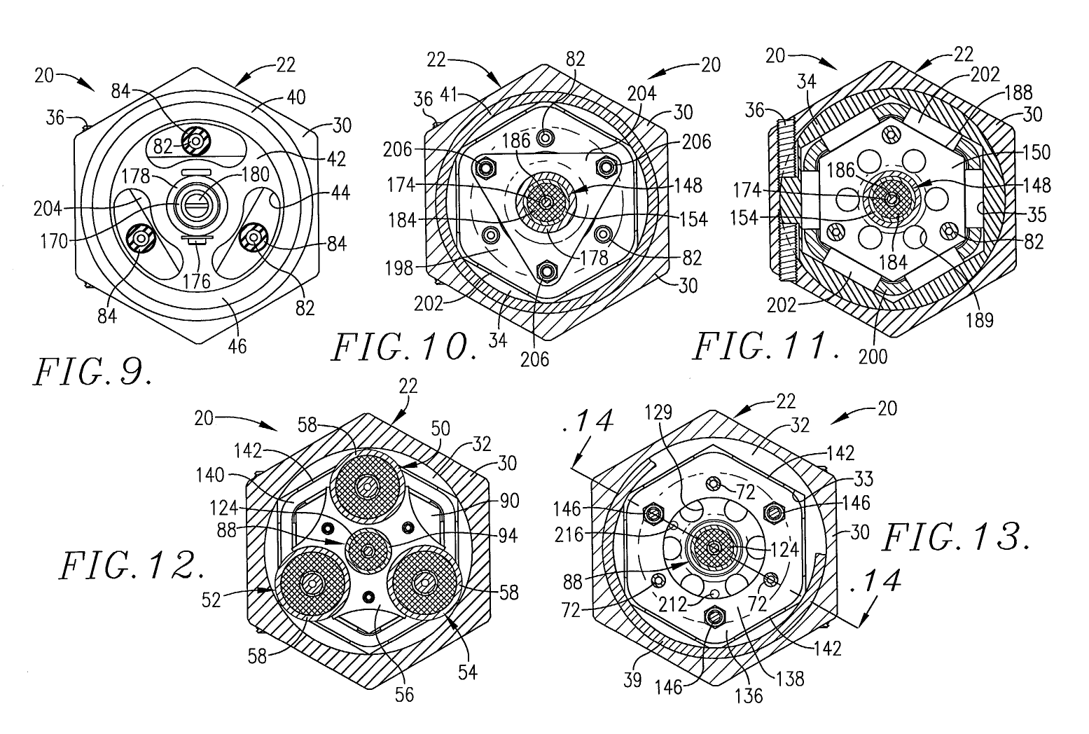

In more detail, the chassis 22 includes an elongated metallic tubular body 30 presenting an hexagonal outer surface and a circular inner surface and having the opposed ends thereof internally threaded. The body 30 has a pair of internal, annular races 32 and 34 respectively located adjacent the forward and rearward ends thereof, and maintained in place by set screws 36 (see FIG. 11); each race has a total of six peripheral planar surfaces 33 and 35, whose axial length essentially represents the extent of possible linear travel for motor 20. In addition, identical forward and rearward caps 38, 40 are threadably secured to the corresponding ends of the body 30 and have flanges 39, 41 abutting the adjacent margins of the races 32, 34. As best seen in FIGS. 3, 6, and 9, the caps 38, 40 include a primary plate 42 having three arcuate cooling air openings 44 therethrough, together with an outwardly extending annular marginal flange 46 equipped with a series of circumferentially spaced, threaded bores 48. A removable air input duct 49 is optionally mounted on cap 40 as shown in FIG. 1.

The main actuator assembly 24 includes three circumferentially spaced, commonly acting primary actuators 50, 52 and 54 supported by a total of three axially spaced apart, somewhat triangular spacers 56. Each of the actuators 50-54 is identical, and therefore only the actuator 50 will be described in detail, and the same reference numerals will be used for each actuator. In particular, the actuator 50 includes an outer tubular casing 58 with an apertured, recessed, annular forward flux ring 60, and a rearmost threaded cap 62, the latter having a central opening 64 and respective passageways 66 for electrical leads 68 (see FIG. 2).

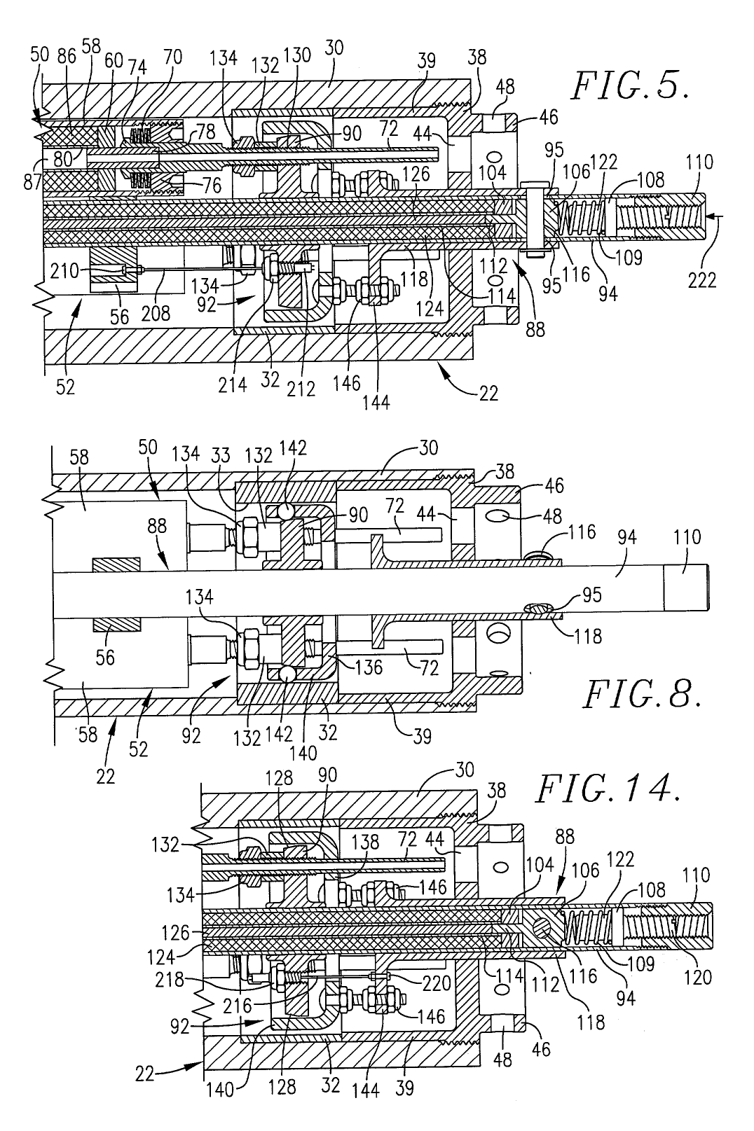

Referring to FIG. 5, it will be seen that the casing 58 extends forwardly from the ring 60 and is internally threaded; an annular belleville washer assembly 70 is located forwardly of the ring 60, and is maintained therein by a main actuator output shaft 72 presenting an inboard shoulder 74, and threaded tensioner 76. It will be seen that the shaft 72 is tubular and carries, adjacent its inner end, a tubular and coaxial main actuator flux plug 78 which extends through the flux ring 60 and into the central magnet/Terfenol housing 80 of the actuator 50.

The rearward end of actuator 50 (FIG. 3) includes an externally threaded, tubular main actuator fixed shaft 82 which is threaded into cap 62. Flexible air tubing 84 is attached to the rearward end of shaft 82 and extends through the associated opening 44 of end cap 40.

The actuator 50 includes an annular coil 86 extending between and abutting the rear cap 62 and forward flux ring 60. The coil 86 is preferably made up of four concentric rows of 16-AWG wire, presenting a theoretical coil outside diameter of 0.69 inches. The central housing 80 has therein a main actuator magnet/terfenol magnetostrictive stack 87 made up of a total of eleven annular magnets and ten hollow magnetostrictive Terfenol rods placed in an alternating fashion. Each magnet has a 0.221 inches O.D., a 0.78 inches I.D. and is 0.212 inches long. Each Terfenol rod has the same O.D. and I.D. as the magnets, and is 0.850 inches long. The stack is constructed with a leading magnet at each end, with alternating Terfenol rod elements and magnets throughout the length of the stack, the latter having a total length of 10.832 inches. In the illustrated embodiment, the Terfenol elements are formed of Terfenol-D whereas the magnets are of the rare earth variety, usually with Samarium Cobalt or Neodymium-Iron-Boride; the magnets produce a bias magnetic flux through the Terfenol-D elements. The washer assembly 70 provides a preload on the stack 87, while the tensioner 76 allows washer assembly adjustment.

The forward clutch assembly 26 includes an elongated secondary cage actuator 88, ramp 90 and a forward clutch cage assembly 92. The actuator 88 is made up of an elongated, tubular casing 94 equipped with an inner threaded plug 96 (FIG. 4) and a spacer 98. As illustrated, the casing 94 includes a passageway 100 for electrical leads 102. The forward end of the actuator 88 includes an annular cage actuator flux ring 104, an output plug 106, threaded tensioner 108, coil spring 109, and output end piece 110. As best shown in FIGS. 5 and 14, the plug 106 includes a central, rearwardly extending projection 112 which extends through flux ring 104 and into the confines of internal tubular housing 114. The plug 106 is coupled within the casing 94 by means of a clevis pin 116, which extends through the plug 106, casing 94 and an external tubular cage sleeve 118 forming a part of the clutch cage assembly 92. Note that the casing 94 is provided with a pair of opposed enlarged openings 95 about the pin 116, whereas the clevis openings through sleeve 118 and plug 106 mate with the clevis diameter (FIG. 5). The tensioner 108 includes a threaded shank 120 which is threaded into end piece 110 and includes a rearwardly extending boss 122. The spring 109 is disposed about the boss 122, and engages the forward face of plug 106. Finally, it will be observed that the end piece 110 is threaded into the extreme forward end of the casing 94. The plug 106, tensioner 108 and end piece 100 define an output for the motor 20.

Internally, the casing 94 has, in addition to the central housing 114, an annular wire coil 124 displayed about the housing and, within the housing, a magnet/Terfenol magnetostrictive stack 126. The coil 124 is made up of four concentric rows of 20-AWG copper wire presenting a theoretical coil O.D. of 0.413 inches. The magnet/terfenol stack 126 is made up of alternating solid magnets and solid Terfenol-D rods with leading magnets at each end and alternating Terfenol-D rods and magnets. Each magnet has a 0.096 inch O.D. and is 0.153 inches long. Each terfenol rod has a 0.96 inch O.D. and is 0.625 inches long. This gives a total stack length of 8.711 inches.

The actuator 88 is supported by means of the middle and righthand spacers 56 (as viewed in FIG. 1). The ramp 90 is fixed to the casing 94 and is generally hexagonal in configuration with rearwardly tapered side margins 128. The ramp also has a series of fore and aft extending cooling air passages 129 (see FIG. 13), as well as threaded bores 130 which receive the threaded shanks of the output shafts 72. As best seen in FIG. 5, each such shaft 72 also supports a spacer 132 and locknut 134.

The forward clutch cage assembly has a generally hexagonal forward roller cage 136 including an apertured main plate 138 and a rearwardly extending peripheral roller mount 140. The latter supports a total of six elongated rollers 142 located adjacent the corresponding tapered margins 128 of ramp 90; as illustrated in FIG. 8, the rollers 142 also engage the planar faces 33 of the forward race 32. The sleeve 118 includes a generally triangular mounting plate 144 which is located adjacent main plate 136, and three screw and lock nut assemblies 146 are employed to interconnect cage 136 and the mounting plate 144. Also, the shafts 72 extend forwardly from ramp 150 and slidably extend through the cage 136.

The rearward clutch assembly 28 is in many respects similar to the forward assembly 26. Broadly, the assembly 28 includes a rearward secondary cage actuator 148, rear ramp 150 and rearward clutch cage assembly 152.

The actuator 148 is made up of an elongated, tubular casing 154 equipped with an inner threaded plug 156 (FIG. 4) and a spacer 158. The casing 154 includes a passageway 160 for electrical leads 162. The rearward end of the actuator 148 includes an annular, cage actuator flux ring 164, a plug 166, threaded tensioner 168, coil spring 169, and end piece 170. As best shown in FIG. 3, the plug 166 includes a central, rearwardly extending projection 172 which extends through flux ring 164 and into the confines of internal tubular housing 174. The plug 166 is coupled within the casing 154 by means of a clevis pin 176, which extends through the plug 166, casing 154 and an external tubular cage sleeve 178 forming a part of the clutch cage assembly 148. Casing 154 has enlarged, opposed openings 179 receiving clevis pin 176, whereas sleeve 178 and plug 166 having mating openings for the clevis pin (FIG. 3). The tensioner 168 includes a threaded shank 180 which is threaded into end piece 170 and includes a forwardly extending boss 182. The spring 169 is disposed about the boss 182, and engages the rearward face of plug 166. Finally, it will be observed that the end piece 170 is threaded into the extreme rearward end of the casing 154.

Internally, the casing 154 has, in addition to the central housing 174, an annular wire coil 184 and, within the housing, a magnet/terfenol magnetostrictive stack 186. The coil and stack 184, 186 are identical with coil 124 and stack 126 of actuator 88.

The actuator 148 is supported by means of the center and lefthand spacers 56 as viewed in FIG. 1; note, however, there is a small space 179a between the adjacent ends of the actuators 88, 148. The ramp 150 is fixed to the casing 154 and is generally hexagonal in configuration with forwardly tapered side margins 188. The ramp also has a series of fore and aft extending cooling air passages 189 (see FIG. 11), as well as bores 190 which receive the shanks of the fixed shafts 82. As best seen in FIG. 3, each shaft 82 also supports a spacer 192 and locknut 194.

The rearward clutch cage assembly 152 has a generally hexagonal rearward roller cage 196 including an apertured main plate 198 and a rearwardly extending peripheral roller mount 200. The latter supports a total of six elongated rollers 202 located adjacent the corresponding tapered margins 188 of ramp 150; as illustrated in FIG. 6, the rollers 202 also engage the planar faces 35 of the rearward race 34. The sleeve 178 includes a generally triangular mounting plate 204 (see FIG. 10) which is located adjacent main plate 196, and three screw and lock nut assemblies 206 are employed to interconnect cage 196 and the mounting plate 204. The fixed shafts 82 extend rearwardly from the ramp 150 and are coupled with cage 196.

The sensor assembly 29 includes a main actuator displacement probe 208 mounted on the righthand spacer 56 via lock nut 210. As illustrated in FIG. 5, the probe 208 extends forwardly and engages a sensor 212 mounted on ramp 90 through lock nut 214. Additionally, the assembly 29 comprises a forward cage actuator displacement probe 216 likewise mounted on ramp 90 by lock nut 218 (FIG. 14). In this instance, the forward end of probe 216 engages lock nut 220 on the forward sleeve 118.

Operation

In the following description, it is assumed that the actuator coils 86, 124 and 184 as well as sensors 212, 216, are operatively coupled with a microprocessor-based power controller and a suitable power source, and that the stack 87 of primary actuators 50-54 are fully contracted. Moreover, owing to the presence of the load 222 (FIG. 5), the forward and rearward clutch assemblies 26 and 28 are loaded and passively locked, i.e., the rollers 142 and 202 are clamped between the ramps 90, 150 and the adjacent race surfaces 33, 35. Normally, cooling air is delivered to the motor 20 through duct 49 and the tubing 84 during operation of the motor.

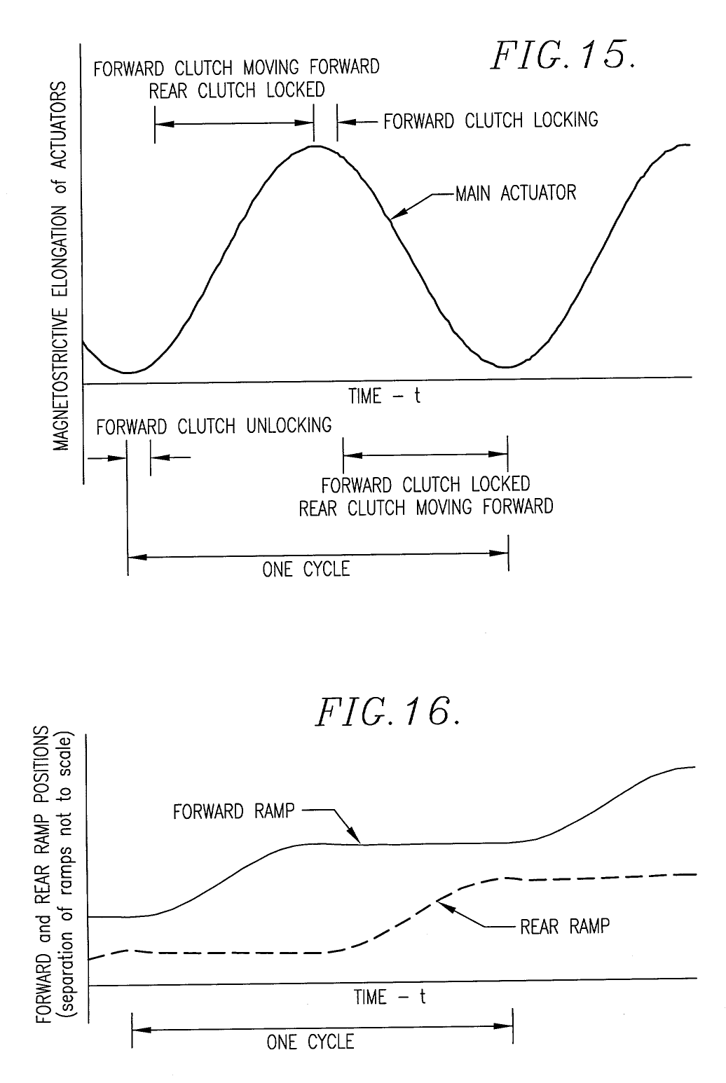

During such operation, the coils 86, 124 and 184 are energized by application of electrical current and generate magnetic flux necessary for expansion or contraction of the Terfenol-D element of the magnetostrictive stacks 87, 126 and 186 at appropriate times during the cycle of operation. The applied current is oscillatory (i.e., alternating) at a frequency of from about 300-1000 Hz, more preferably about 500 Hz, and can take a variety of forms such as sinusoidal, square wave or sawtooth; in the preferred embodiment a waveform is used which is a parabolic function of time (see FIG. 15) because it provides a nearly minimized acceleration of the external load during each current cycle for a given rate of motion. When the main magnetostrictive stacks 87 are actuated, linear motion is ultimately provided either to the forward ramp 90 or rearward ramp 150, depending upon whether the corresponding clutch assemblies are engaged. Both clutch assemblies are free to move forwardly when the corresponding ramp 90 or 150 is moved forwardly so as to unclamp the rollers 142 or 202. Conversely, when by the actuators 50-54, 88 and 148 and not activated, the load 222 serves to lock both clutch assemblies in place. It will thus be appreciated that the clutch assemblies 26, 28 are passively-locked, actively-disengaged, one-way linear clutches.

Also, during operation, the optional sensor assembly 29 detects the motion of the actuators 50-54 and 88, 148 and resultant control signals are used by the controller to fine adjust the forward and rearward motion of the motor.

In more detail, and considering forward movement of the linear motor 20 against the load 222, the controllers increases the current to the coils 87 of the primary actuators 50-54. The current causes the magnetostrictive elements of the primary actuators 50-54 to extend, thereby moving the output shafts 72 and ramp 90 slightly forwardly to unload the forward clutch. This also moves the actuator 148 forwardly until such time as clevis pin 116 engages the forward extents of the enlarged casing openings 95 (FIG. 5). At this point, continued expansion of the stacks 87 causes the entire clutch assembly 26 to disengage and move forwardly. Such movement continues until the primary actuators 50-54 reach their maximum extension. At this point, the magnetostrictive elements 87 of the primary actuators begin to contract, resulting in locking of the forward clutch assembly 26. This occurs because of the rearward movement of ramp 90 and also because load 222 acts against cage 136 to shift it rearwardly, thereby clamping the rollers 142 between the ramp surfaces 128 and the race surfaces 33.

Given that the forward clutch assembly 26 is locked and the actuators 50-54 are contracting, the actuators begin pulling the primary actuator rear shafts 82 forwardly, unloading and releasing the rear clutch assembly 28; again, this occurs because of forward movement of ramp 150 so that the rear rollers 202 are no longer clamped between the ramp marginal surfaces 188 and the race surfaces 35. This continues until the magnetostrictive elements 87 again reach their minimum or contracted condition, whereupon the rear clutch assembly 28 again locks under the influence of load 222. This returns the actuator 20 to its neutral position.

The process described above is repeated until the desired overall forward motion has been achieved. Thus, such motion can be described as inchworm-style motion. The corresponding movement of the external load 222 is attained through the motion of the forward roller cage 136 because of the output end piece 110 is tied directly to the forward clutch assembly 26. The spring 109 is operable to maintain the appropriate compression on the magnetostrictive elements 87 of the primary actuators 50-54.

FIGS. 15 and 16 illustrate the magnetostriction control strategy for forward motion of the linear motor 20. FIG. 15 represents the magnetostrictive elongation of the primary actuator magnetostrictive elements 87 versus time. The forward motion of the forward clutch assembly 26 is represented by the upward slope of the curve, when the elements 87 are expanding against the primary output shafts 72. Just after the peak extent of such elongation, the forward clutch assembly 26 again locks, at which point the rear clutch assembly 28 is released and moved forwardly until the magnetostrictive elements 87 reach their minimum extent corresponding to the lowest point of the plot. The distance from this minimum point to the next consecutive minimum point represents one complete cycle of forward motion. FIG. 16 represents the position of the forward and rearward ramps 90, 150 during this cyclic motion. It can be seen that, through one cycle of forward motion, the forward ramp 90 moves forward first, followed by the rear ramp 150 near the end of the cycle.

In summary, forward motion is achieved using the following control strategy, with the motor 20 in a neutral position with both clutch assemblies locked and the primary actuator magnetostrictive stacks at their full contracted positions:

Step 1—the forward clutch assembly 26 is unloaded and moves forwardly under the action of the positive increasing current/flux in the primary actuators 50-54.

Step 2—forward movement of the forward clutch assembly 26 continues until the main actuators 50-54 reach their maximum extended position.

Step 3—the primary actuators 50-54 begin to contract, locking the forward clutch assembly 26.

Step 4—rearward clutch assembly 28 is unloaded and moves forwardly as the primary actuators 50-54 contract.

Step 5—the rearward clutch assembly 28 continues moving forwardly until the primary actuators 50-54 reach their minimum contracted position.

Step 6—the rear clutch assembly 28 locks as the primary actuator stacks begin to extend again.

Reverse or rearward motion of the motor 20 is accomplished as follows. This motion begins in a fashion similar to the process of forward motion. During the initial step, the primary actuator magnetostrictive elements 87 are activated to cause extension thereof. This causes the primary actuator output shafts 72 to move ramp 90 forwardly so that the forward rollers 142 are released from their clamped position between their forward ramp 90 and race surfaces 33, resulting in unloading and forward movement of the entire forward clutch assembly 26 once pin 116 bottoms out against the forward margins of the slots 95; the rear clutch assembly 28 remains engaged because of the actions of external load 222 and primary actuators 50-54.

In the next step, the controller operates to begin contracting the stack 124 of forward actuator 88. This occurs because the current to coil 124 is terminated or applied at a magnitude to effect the contraction. The actuator 88 begins to contract before the primary actuators 50-54 have reached their maximum expansion. As the actuator 88 contracts, the forward roller cage 136 is pulled rearwardly, and the forward clutch rollers 142 are pulled away from ramp 90. This results in unloading and release of the forward clutch assembly 26, before the maximum extension of the primary actuators is attained. As the forward clutch actuator 88 contracts, the primary actuators 50-54 continue and complete their extension, continuing to move the forward ramp 90 forwardly. The forward clutch assembly 26 remains disengaged throughout this step, while the rear clutch remains locked, maintaining control of the external load 222. An important benefit of the present invention is realized during this step. Because the disengagement of the forward clutch rollers 142 occurs while the forward ramp 90 is being moved forwardly by primary actuators 50-54, the clutch rollers 142 are unloaded before they are moved away from the ramp 90. This avoids disengagement under load which can result in excessive wear and damage to the clutch mechanism.

In the next step, the primary actuators 50-54 begin to contract as current is removed from the coils 86. As the primary actuators contract, the forward roller cage 136, which is still disengaged, is moved rearward as a unit with forward ramp 90. Therefore, the external load 222 moves backward with the forward clutch assembly 26. When the primary actuators 50-54 have attained approximately 75% of their contraction, the forward clutch assembly 26 is again engaged by decreasing the current in the forward clutch actuator coil 124. This forces the forward roller cage 146 forwardly, clamping the forward clutch rollers 142 between forward ramp 90 and race surfaces 33. This locks the forward clutch assembly 26. The reverse motion of the external load is then stopped, but the external load has moved rearwardly from its initial position.

In the next step, the primary actuators 50-54 complete their contraction, pulling the primary actuator fixed shafts 82 forwardly, thereby moving rear ramp 196 forwardly. The locked forward clutch assembly 26 remains fixed, preventing undesired forward motion of external load 222.

As soon as the rear ramp 196 is moving forwardly, the rear clutch actuator 148 is activated by increasing current in the rear actuator coil 184. This causes the rear roller cage 196 to move rearwardly, away from ramp 150, removing the rear clutch rollers 202 from their clamped position between ramp 150 and race surfaces 35, thus disengaging the rear clutch assembly 28. Again, as with the forward clutch assembly 26, by disengaging the rear clutch rollers 202 while the rear ramp 150 is moving forwardly, the rollers 202 are unloaded before they are moved away from the ramp 150, preventing excessive wear and damage to the rollers.

As the rear clutch actuator 148 is contracting, the primary actuators 50-54 complete their remaining approximately 25% of contraction. During this remaining contraction, the rear ramp 196 continues to move forwardly, while the forward clutch assembly 26 remains locked.

In the next step, the primary actuators 50-54 begin their expansion again due to increasing current in the primary coils 86. Because the rear clutch assembly 28 is still disengaged, the rear ramp 196 is free to move rearwardly as the primary actuators 50-54 push against the fixed shafts 82. The rear roller cage 196 thus moves rearwardly as a unit with rear ramp 150, providing reverse motion of this portion of the motor.

During the next step, at approximately 75% of the full extension of the primary actuators, the rear clutch actuator 148 is deactivated and begins to contract. This immediately locks the rear clutch assembly 28 because the rear roller cage 196 is pulled slightly forwardly, clamping the rear clutch rollers 202 between ramp 150 and race surfaces 35. The rear clutch assembly 28 has moved approximately the same distance in reverse as the forward clutch moved previously.

This returns the motor to its beginning state. However, the primary actuators must complete the remaining portion of their extension. Because the rear clutch assembly is now locked, the forward ramp 90 is forced to move forwardly for the remaining approximately 25% of the primary actuator extension. This starts the cycle of reverse over at the initial step, with the forward movement of the forward clutch assembly 26.

This process is repeated, with the primary actuators 50-54 and forward and rear clutch cage actuators 88, 148 being cycled at high frequency, until the desired overall rearward motion has been achieved. The overall reverse motion can thus be described approximately as a one-quarter step forward, three-quarter step rearward motion, resulting in net reverse movement of the motor and load 222. It will be appreciated that reverse motion occurs at approximately one-half the rate of forward motion, given the same current amplitude and frequency.

FIG. 16 graphically depicts the magnetostriction control strategy for reverse motion. As shown, the plot represents the magnetostrictive elongation of the primary magnetostrictive elements 87 as well as the forward and rearward actuators 88, 148 versus time. This plot depicts the elongation and contraction of the respective actuators throughout the reverse motion cycle, as well as the periods when the forward and rearward clutch assemblies 26, 28 are locked.

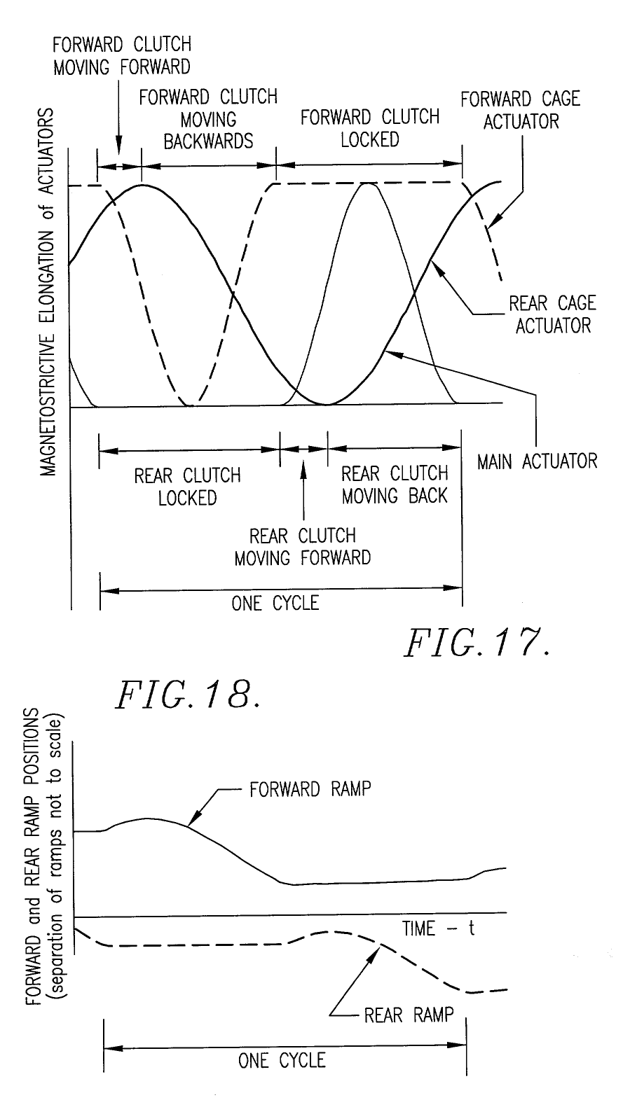

FIG. 17 is a plot representing the positions of the forward and rearward ramps 90, 150 during reverse motion. The unlocking of the forward and rearward clutch assemblies 26, 28 can also be seen in this plot, as can the separate reverse motion of the respective clutch assemblies 26, 28.

In summary, reverse motion of the motor 20 is obtained using the following control strategies.

Step 1—forward clutch assembly 26 is unloaded and moves forwardly under the action of a positive increasing coil current/flux in primary actuators 50-54.

Step 2—forward cage actuator 88 begins contracting before the main actuators 50-54 reach their fully extended condition, thereby releasing the forward clutch assembly 28.

Step 3—forward ramp 90 continues moving forwardly until the primary actuators 50-54 reach their maximum extended condition.

Step 4—primary actuators 50-54 begin to contract, and the forward clutch assembly 26 is unloaded and moves rearwardly.

Step 5—forward cage actuator 88 begins to extend as the forward ramp 90 is moving rearwardly, reengaging the forward clutch assembly 26 and stopping the reverse motion of the forward clutch assembly before the primary actuators 50-54 complete their full contraction.

Step 6—rearward ramp 150 moves forwardly as the primary actuators 50-54 continue their contraction.

Step 7—the rear cage actuator 148 begins to extend, causing the rear cage 200 to move rearwardly from the rearward ramp 150, thereby disengaging the rear clutch assembly 28.

Step 8—rearward ramp 150 continues moving forwardly until the main actuators reach their minimum contracted condition.

Step 9—rearward ramp 150 moves rearwardly as the primary actuators 50-54 begin their next expansion stroke; the rearward cage 200, which has been disengaged by the rear cage actuator 148, moves backward as a unit with a rearward ramp 150, generating reverse motion of the rear clutch assembly 28.

Step 10—rear cage actuator 148 contracts, stopping the rearward motion of rearward ramp 150 short of a full stroke, causing the rear clutch assembly 28 to engage and lock.

Step 11—primary actuators 50-54 continue their expansion stroke, moving the forward ramp 90 forwardly.

This entire process then repeats starting with step 2 to effect reverse motion.

From the foregoing description, it will be apparent that in principle, the motor 20 has an output (comprising plug 106, tensioner 108 and endpiece 110) adapted for coupling with an external load 222 for selective, preferably bidirectional, translation of the load in a precise manner. A drive is coupled with the output and is broadly made up of a current-responsive overall actuator assembly (comprising primary actuators 50-54 and secondary actuators 88 and 148 of the clutch assemblies 26, 28, each actuator equipped with a device which will alternately and controllably expand and contract) for output translation, together with clutch assemblies 26, 28 coupled with the actuator assembly. The clutch assemblies each have first and second interengageable components (ramps 90, 150 and cages 13, 196) and can assume engaged and disengaged positions.

The clutch assemblies 26, 28 are positioned on opposite sides of the primary actuators 50-54 with each end of the primary actuators coupled with one of the clutch components (namely the ramps 90, 150); in this way, the coupled clutch components move away from each other upon expansion of the actuators 50-54, and towards each other upon actuator contraction. The secondary actuator 88, 148 are coupled to the other clutch assembly components (i.e., the cages 136, 196) so that these components likewise move toward and away from each other upon contraction and expansion of the secondary actuators.

Of particular importance is the preferred method by which the clutch assemblies 26, 28 are released in the motor 20. For example, at the beginning of each forward or reverse motion cycle, the primary actuators 50-54 release the forward clutch assembly 26 by slightly moving the forward ramp 90 in the forward direction so as to unload the rollers; this allows the forward clutch assembly to then be disengaged and moved. An alternative release method would be to force the cage 136 in a reverse direction against the load. However, it is believed that this release method would lead to excessive roller damage owing to the frictional forces which would be developed over many cycles of motion, thus altering the overall performance of the motor. By moving the ramp 90 via the actuators 50-54 (i.e., the ramp is under the active control of the actuators), friction is created only between the rollers 142 and the ramp 90, and not between the rollers 142 and race surfaces 33, making this method of clutch release more desirable.

Although the motor 20 has been described in complete, preferred detail, it will be appreciated that the invention is not limited to this specific embodiment. As noted previously, use can be made of piezoelectric assemblies in lieu of the preferred magnetostrictive stacks. By way of further example, the three primary actuators 50-54 may be replaced with a lesser or greater number of primary actuators, so long as the actuators provide sufficient power to generate output motion at a desired rate. Also, the sensor assembly 29, while useful for obtaining the most precise motor control, is not essential. Finally, while the motor 20 is a linear motor, it will be appreciated that the principles of the invention may be employed for the construction of rotary output motors.

1. A drive motor, comprising:
an output adapted for coupling with an external load for selective load movement; and
a drive operatively connected with the output for selective movement thereof, including a current-responsive, selectively activatable actuator assembly operable for translation of the output in order to move said external load, and a pair of spaced-apart, translation-controlling clutch assemblies coupled with the actuator assembly,
each of said clutch assemblies having respective, alternately assumable engaged and disengaged positions,
at least one of said clutch assemblies assuming the engaged position thereof under the influence of said external load when the actuator assembly is deactivated.

2. The motor of claim 1, both of said clutch assemblies assuming the engaged positions thereof under the influence of said external load when the actuator assembly is deactivated.

3. The motor of claim 1, said actuator assembly comprising a device which will alternately expand and contract.

4. The motor of claim 3, said device comprising a magnetostrictive stack.

5. The motor of claim 1, including individual race surfaces respectively adjacent said clutch assemblies, each of said clutch assemblies including a cage carrying a plurality of rollers and a ramp, said ramp and cage being relatively movable between a clutch engaged position where said rollers are clamped between the ramp and the corresponding race surface, and a clutch disengaged position where said rollers are unclamped.

6. The motor of claim 5, said drive comprising:
at least one primary actuator including a magnetostrictive stack; and
first and second, opposed clutch cage actuators each including a magnetostrictive stack,
said clutch assemblies disposed on opposite sides of said primary actuator with the primary actuator coupled to the ramps for movement of the ramps in response to magnetic field-induced movement of the primary actuator magnetostrictive stack,
said clutch cages each coupled to one of said clutch cage actuators.

7. The motor of claim 6, there being a plurality of primary actuators each including a magnetostrictive stack and each coupled with said ramps.

8. The motor of claim 6, said output operatively coupled with one of said clutch cage actuators.

9. The motor of claim 5, including a chassis disposed about said drive and supporting said race surfaces.

10. The motor of claim 1, said drive operable to selectively move said output in opposite first and second directions.

11. The motor of claim 1, including a sensor assembly operably coupled with said drive for sensing the position of said output during operation of the drive motor.

12. The motor of claim 1, said actuator assembly including a primary magnetostrictive actuator, said clutch assemblies located on opposite sides of said primary magnetostrictive actuator, each of the clutch assemblies having first and second selectively interengageable components, said primary magnetostrictive actuator operably coupled with said first clutch components of both of said clutch assemblies for movement of the first components away from each other upon expansion of the primary magnetostrictive actuator and movement of the first components towards each other upon contraction of the primary magnetostrictive actuator, said clutch assemblies assuming the disengaged positions thereof upon movement of the first components in the same direction.

13. The motor of claim 12, said actuator assembly further including opposed secondary magnetostrictive actuators, each of the secondary actuators operably coupled with the second component of one of the clutch assemblies, said secondary actuators operable to move the corresponding second clutch components away from each other upon expansion of the secondary actuators, and towards each other upon contraction of the secondary actuators.

14. The motor of claim 13, said actuator assembly operable to move said first and second clutch components of each clutch assembly in either of two opposite directions.

15. The motor of claim 12, each of said first clutch components comprising a ramp presenting an engagement surface, each of said second components comprising a cage supporting a roller, said rollers and engagement surfaces oriented for engagement in order to engage the corresponding clutch assemblies.

16. In an inchworm-type method of moving a motor including an output coupled to an external load in a first direction to thereby move the load in the first direction, the motor having said output, structure trailing the output, a drive operably coupled with the output and trailing structure for movement thereof including a selectively activatable actuator assembly operable for alternate translation of the output and trailing structure, and a pair of translation-controlling clutch assemblies operably coupled with the actuator assembly and capable of alternately assuming engaged and disengaged positions, the method including the steps of activating the actuator assembly to disengage one of the clutches, translating said output in said first direction, engaging said one clutch, disengaging the other clutch and translating said trailing structure in the first direction, the improvement which comprises the step of engaging said one clutch by discontinuing the translation of the output and causing said external load to engage the one clutch assembly.

17. The method of claim 16, including the step of causing said external load to engage the other of said clutch assemblies after completion of said translation of said trailing structure.

18. A motor comprising:
a chassis presenting an output end;
a bidirectionally movable output adjacent said output end; and
a drive operably connected with said output for selective bidirectional movement thereof, including a current-responsive, selectively activatable actuator assembly for alternate translation of the output in opposite first and second directions, and a pair of spaced-apart, translation-controlling clutch assemblies coupled with the actuator assembly,
said actuator assembly including a primary actuator having a current-responsive primary device which is alternately expandable and contractible,
said clutch assemblies located on opposite sides of said primary actuator and each having first and second selectively interengageable components and capable of alternately assuming engaged and disengaged positions, said primary actuator operably coupled with the first clutch components of both of said clutch assemblies for movement of the first components away from each other upon expansion of said device and movement of the first components towards each other upon contraction of the device, said clutch assemblies assuming the disengaged positions thereof upon movement of the first components in the same direction,
said actuator assembly further including opposed secondary actuators each having a current-responsive secondary device which is alternately expandable and contractible, each of the secondary actuators operably coupled with the second components of one of the clutch assemblies, said secondary actuators operable to move the corresponding second clutch components away from each other upon expansion of the secondary actuators, and towards each other upon contraction of the secondary actuators.

19. The motor of claim 18, said primary device and said secondary devices each comprising a magnetostrictive stack.

20. The motor of claim 18, said actuator assembly operable to bidirectionally move said first and second clutch components of each clutch assembly, when the clutch assemblies are in the disengaged positions thereof.

21. The motor of claim 18, each of said first clutch components comprising a ramp presenting an engagement surface, each of said second components comprising a cage supporting a roller, said rollers and engagement surfaces oriented for engagement in order to engage the corresponding clutch assemblies.

22. A method of operating a motor having an output coupled to an external load in a selected direction so as to correspondingly move the load in the selected direction, including the steps of, in a single predetermined motor cycle, first moving said output in a direction opposite to selected direction for an initial distance, and then moving the output in the selected direction a distance greater than said initial distance, resulting in net movement of the output in the selected direction.

23. A method of operating a motor comprising:
a chassis presenting an output end;
a bidirectionally movable output adjacent said output end; and
a drive operably connected with said output for selective bidirectional movement thereof, including a current-responsive, selectively activatable actuator assembly for alternate translation of the output in opposite first and second directions, and a pair of spaced-apart, translation-controlling clutch assemblies coupled with the actuator assembly,
said actuator assembly including a primary actuator having a current-responsive primary device which is alternately expandable and contractible,
said clutch assemblies located on opposite sides of said primary actuator and each having first and second selectively interengageable components and capable of assuming engaged and disengaged positions, said primary actuator operably coupled with the first clutch components of both of said clutch assemblies for movement of the first components away from each other upon expansion of said device and movement of the first components towards each other upon contraction of the device, said clutch assemblies assuming the disengaged positions thereof upon movement of the first components in the same direction,
said actuator assembly further including opposed secondary actuators each having a current-responsive secondary device which is alternately expandable and contractible, each of the secondary actuators operably coupled with the second components of one of the clutch assemblies, said secondary actuators operable to move the corresponding second clutch components away from each other upon expansion of the secondary actuators, and towards each other upon contraction of the secondary actuators,
said method comprising the steps of:
activating said primary actuator to cause expansion of said primary device to unload the one of said clutch assemblies adjacent said output at its initial position, and thereafter moving the one clutch assembly and said output in a first direction;
prior to complete expansion of said primary device, activating the secondary actuator coupled with the second component of the one clutch assembly to cause contraction thereof and disengagement of the one clutch assembly;
allowing the primary actuator to complete the expansion thereof;
causing said primary actuator to contract from the completely expanded position thereof, so that the one clutch assembly and said output move in a second direction opposite said first direction with one clutch assembly and its output moving in the second direction pas the initial position thereof;
prior to complete contraction of the primary actuator, actuating the secondary actuator coupled with the second component of the one clutch assembly to cause expansion thereof, thereby engaging the one clutch assembly and stopping the motion of the one clutch assembly and the output in said second direction;
activating the other of said secondary actuators to cause expansion thereof, thereby disengaging the other clutch assembly;
allowing the primary actuator to complete the contraction thereof and to unload said second clutch assembly at its initial position and thereafter moving the second clutch assembly in the first direction;
again activating the primary actuator to re-expand the primary actuator; and
again activating the other of said secondary actuators for expansion thereof so that the second clutch assembly moves in a second direction opposite said first direction with second clutch assembly moving in the second direction pas the initial position thereof; and
prior to complete expansion of the primary actuator, again activating the other of said secondary actuators coupled with the second component of the second clutch assembly for expansion thereof, thereby engaging the second clutch assembly and stopping the motion of the second clutch assembly in said second direction.

24. A motor comprising:
a shiftable output adapted for coupling with a load to be moved;
an actuator assembly operable for selective incremental shifting of said output and including a selectively activatable current-responsive device which alternately expands and contracts under the influence of an applied electrical current in order to effect said incremental shifting; and
a first clutch assembly operably coupled between said actuator and said output, said first clutch capable of assuming an engaged position inhibiting shifting of the output and a disengaged position permitting actuator assembly-powered incremental shifting of the output and coupled load, said first clutch assembly biased to said engaged position under the influence of said load and movable to the disengaged position upon activation of said actuator assembly.

25. The motor of claim 24, said motor including first and second clutch assemblies, respectively located on opposite sides of said device and each capable of alternately assuming engaged and disengaged positions, both of said clutch assemblies biased to the engaged position under the influence of said load.

26. The motor of claim 24, said device comprising a magnetostrictive stack.
